(19) United States
(12) Patent Application Publication
(10) Pub. No.: US 2014/0067799 A1
(43) Pub. Date: Mar. 6, 2014

(54) TECHNIQUES TO TRACK MUSIC PLAYED

(71) Applicants: Michael Zolfo, New York, NY (US); Mona Fawzy, New York, NY (US)

(72) Inventors: Michael Zolfo, New York, NY (US); Mona Fawzy, New York, NY (US)

(73) Assignee: CBS INTERACTIVE INC., San Francisco, CA (US)

(21) Appl. No.: 13/600,934

(22) Filed: Aug. 31, 2012

(51) Int. Cl. G06F 17/30

(52) U.S. Cl. 707/733; 707/E17.059

(57) ABSTRACT

Techniques to track and store music played at venues are described. A computer implemented application may create venue profiles for one or more venues. A venue profile may comprise a venue name, venue address, and one or more music genres indicative of the type of music played at the venue. The computer implemented application may collect, in real-time, music data from the one or more venues. The music data may comprise venue data, a song title, an artist name, and a date, the music data indicative of music played at the one or more venues. The computer implemented application may store the venue profiles and music data in a database where the data may be mined. Other embodiments are described and claimed.

### BACKGROUND

Selecting a venue to enjoy a night out that plays music, either live or over a sound system, can be difficult. Even savvy computer users searching for information on the Internet would have to find venues on their own and see if the venues maintain a website that provides the type of music information sought. Such a process is laborious and not guaranteed to provide satisfactory results. Other sources of information may include recommendations from friends and media reviews of the venue. Even if such information were available, it is subjective in nature and limited to the experience of the source for a particular date only. What is needed is a searchable and interactive system that can provide venue specific music data on a real-time basis. Such a system would allow a user to instantly locate a nearby venue that is a good musical fit for the user and friends.

### SUMMARY

Various embodiments are generally directed to techniques to track music that is played at venues such as bars and nightclubs. Some embodiments are particularly directed to techniques to receiving and storing the music played at a venue in a real-time song by song basis. This data may be stored and accessed by a variety of different users for a variety of different reasons. In one embodiment, for example, a system may comprise a processor component executing on a web server and controlling a website. A venue user component may interact with multiple venues to receive and process input from venues that play music and store that data in a database. The venue user component may also collect profile data on each venue and allow each venue to submit promotional data that can be accessed by mobile users. A mobile user component may interact with multiple mobile users to provide the mobile users with real-time information pertaining to the music being played at a particular venue as well as other information about the venue. A business user component may interact with business users to allow such users to search and query a database of the music played at venues. Other embodiments are described and claimed.

Certain illustrative aspects are described herein in connection with the following description and the annexed drawings. These aspects may be indicative of the various ways in which the principles disclosed herein can be practiced. In addition, these aspects and any equivalents are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a block diagram of an embodiment of a music tracking system.

FIG. 2 illustrates an embodiment of a venue user component within the music tracking system.

FIG. 3 illustrates an embodiment of a venue user device communicable with the music tracking system.

FIG. 4 illustrates an embodiment of a computer screen image for entering data pertaining to a venue profile.

FIG. 5 illustrates an embodiment of a computer screen image for entering data pertaining to a venue event schedule.

FIG. 6 illustrates an embodiment of a mobile user component within the music tracking system.

FIG. 7 illustrates an embodiment of a mobile user device communicable with the music tracking system.

FIG. 8 illustrates an embodiment of a computer screen image for entering data pertaining to a user music profile.

FIG. 9 illustrates an embodiment of a computer screen image for entering data pertaining to a venue search.

FIG. 10 illustrates an embodiment of a computer screen image for showing results pertaining to a venue search.

FIG. 11 illustrates an embodiment of a computer screen image for entering data pertaining to a song request.

FIG. 12 illustrates another embodiment of a computer screen image for entering data pertaining to an artist.

FIG. 13 illustrates another embodiment of a computer screen image for entering data pertaining to a song.

FIG. 14 illustrates an embodiment of a business user component within the music tracking system.

FIG. 15 illustrates an embodiment of a business user device communicable with the music tracking system.

FIG. 16a illustrates an embodiment of a computer screen image for entering data pertaining to a music search.

FIG. 16b illustrates an embodiment of a computer screen image for providing search results pertaining to a music search.

FIG. 17 illustrates an embodiment of a logic flow.

FIG. 18 illustrates an embodiment of a logic flow.

FIG. 19 illustrates an embodiment of a logic flow.

FIG. 20 illustrates an embodiment of a computing architecture.

### DETAILED DESCRIPTION

Creating a real-time interactive music application that allows mobile users the ability to instantly evaluate or receive recommendations regarding a venue's musical offerings could significantly enhance the visibility of a venue to a target demographic of customers. Friends that are trying to decide where to go for an evening may access and use a web-based music application that can be searched to locate venues playing specific genres of music. For mobile devices, the music application may be locally installed for instant access. In addition, the ability to collect data pertaining to music played at multiple venues creates a heretofore non-existent music database that, when mined, may be of significant value to a variety of business users.

Various embodiments described herein may be implemented as part of a music tracking system. The music tracking system is a web-based tool (e.g., music tracking website) that may be used to collect data about the music being played at multiple venues and with which users may interact to locate venues playing specific music. Alternatively, a mobile application may be used to allow users in real-time to detect what music is playing at a specific venue and communicate that information back to a central repository (e.g., music tracking website) and/or to other users.

The music tracking website may be logically divided according to the types of users it can serve. For instance, there may be an aspect to the music tracking website that caters to venues that play music. There may be an aspect to the music tracking website that caters to users of mobile devices that can search for music by venue. There may also be an aspect to the music tracking website that caters to business users that wish to mine the acquired music data from the venues and the mobile users.

The website may enroll multiple venues to participate. The venues may provide profile information that describes the type of music played at the venue as well as contact information. The venues may then provide to the music tracking website, on a real-time basis, updates of the music being played at the venue. The music data may then be stored in a database along with other pertinent data points such as, the venue, date, and time a particular song by a particular artist was played. The venues may also provide the music tracking website with promotional data and/or upcoming event data that may also be stored by the music tracking website in a database. The promotional data and event data may be searchable by individual mobile device users to locate events or promotions that may be of interest. The promotional data and event data may also be pushed out to mobile devices using a push notification scheme that a mobile user may opt into.

The website may also enroll multiple individual users via their mobile devices to the music tracking website. The mobile users may then search the databases of the music tracking website to find venues that match with their musical tastes. Once a venue or venues have been located, the mobile user can select one of the venues to find out more about the venue including the song currently being played as well as a playlist of the last several songs played. If there are any special promotions or events occurring at the venue, the details may be presented to the mobile user too. The mobile user can then decide if this venue is one the mobile user may wish to patronize.

In addition, once at the venue, the mobile user may be afforded the opportunity to interact with the venue and/or provide the user an opportunity to report back to the music tracking website what songs are playing (e.g., by using audio fingerprinting technology). User interaction with a venue may include the ability to receive real-time streamed playlist data, make song requests, and provide feedback to the venue indicating likes and dislikes, etc. For example, song requests may be sent directly to a device within the venue that is involved with the playing of music. The details of the request and other information may also be forwarded to the music tracking website for storage in a database. This way, the music tracking website is able to keep track of music that has been requested in addition to music that is actually played.

The website may further enroll multiple business users to the music tracking website. A business user may include a licensing agency such as the American Society of Composers, Authors, and Publishers (ASCAP) or Broadcast Music, Inc. (BMI). The licensing agency may be able to mine the music data of the website in an effort to help police royalties for the artists. A business user may also include an artist. An artist may wish to mine the music data to determine how often and where their music is being played and/or requested. A business user may also include a music industry reporting agency like Billboard™. The reporting agency could mine the music data to create an additional category of music reporting chart based on venue play (as opposed to airplay).

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

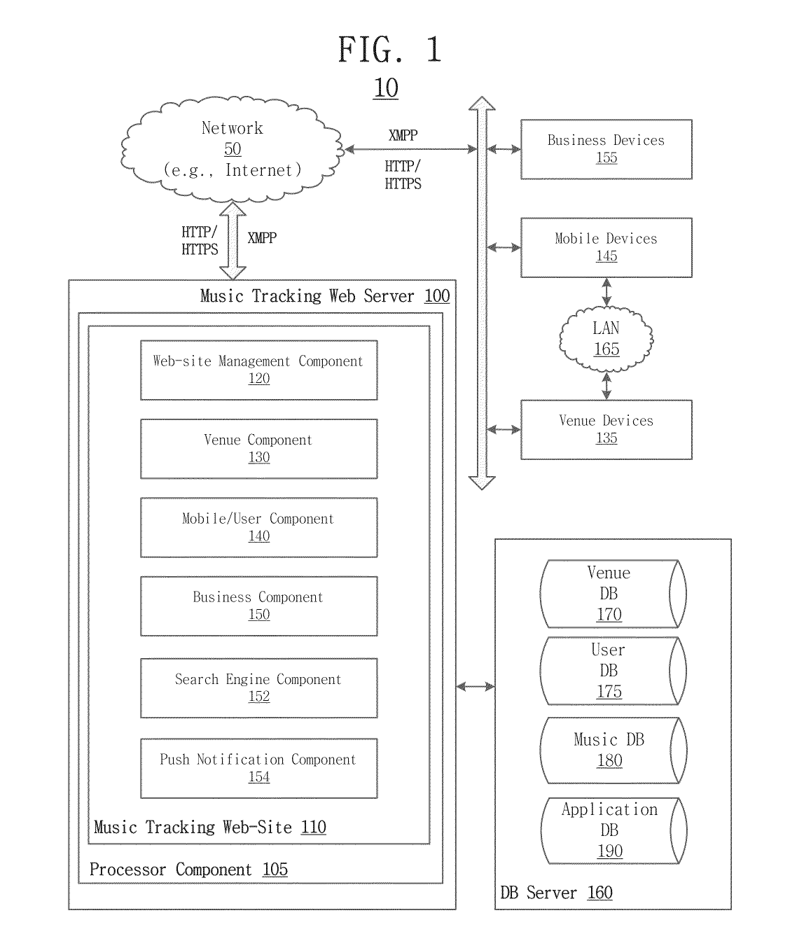

FIG. 1 illustrates a block diagram of an embodiment of a music tracking system 10. In one embodiment, the system 10 may comprise a computer-implemented system having one or more components. Although the system 10 shown in FIG. 1 has a limited number of elements in a certain topology, it may be appreciated that the system 10 may include more or less elements in alternate topologies as desired for a given implementation.

The system 10 may include a network device, such as a music tracking web server 100. The music tracking web server 100 may be generally arranged to host and execute one or more additional music tracking system components. For instance, the music tracking web server 100 may host a music tracking website 110. The music tracking website 110 may be stored on the music tracking web server 100 and operable on a processor component 105.

When a user via a web browser seeks access to the music tracking website 110, access may be granted over a connection such as, for instance, the Hypertext Transfer Protocol (HTTP). HTTP is an application protocol for distributed communication among networked computers. HTTP is the protocol to exchange or transfer hypertext. HTTP functions as a request-response protocol in the client-server computing model. In this case, a web browser, for example, may be the client and an application running on processor component 105 hosting music tracking website 110 may be the music tracking web server 100. The client submits an HTTP request message to the music tracking web server 100. The music tracking web server 100, which provides resources such as Extensible Markup Language (XML) files, Hypertext Markup Language (HTML) files and other content, or performs other functions on behalf of the client, returns a response message to the client. The response contains completion status information about the request and may also contain requested content in its message body.

Certain parts of music tracking website 110 may include information and applications that are specific and unique to individual users of the music tracking website 110. Thus, when one of these users accesses the music tracking website 110, it can be done over a secure connection such as, for instance, the Hypertext Transfer Protocol Secure (HTTPS) or other secure communications protocol.

HTTPS is a communications protocol for secure communication over a computer network. HTTPS is widely deployed on the Internet. HTTPS is the result of layering HTTP on top of a secure socket layer (SSL)/transport layer security (TLS) protocol, thus adding the security capabilities of SSL/TLS to standard HTTP communications. HTTPS may provide authentication of the music tracking website 110 and associated music tracking web server 100 with which a remote computer is communicating over a network. HTTPS provides bidirectional encryption of communications between a client and music tracking web server 100, protecting against eavesdropping and tampering with and/or forging the contents of a communication. In the present example, HTTPS provides a reasonable guarantee that a remote computer is communicating with the intended music tracking website 110 and ensures the contents of communications between the user and music tracking website 110 cannot be read or forged by a third party. Other protocols may be used as well, and the embodiments are not limited in this context.

For example, one such other protocol may be the Extensible Messaging and Presence Protocol (XMPP). XMPP is an open-standard communications protocol for message-oriented middleware based on XML that is particularly adept at instant messaging (IM) or “chat” type communications between/among networked computer devices. The architecture of an XMPP network is similar to email in that anyone can run an XMPP server and there is no central master server. Thus, the music tracking web server 100 may include and incorporate an XMPP server and/or XMPP server functionality to communicate with clients such as venues and users.

The music tracking web server 100 may be communicable over a network 50 such as, for instance, the Internet. In turn, the network 50 may be communicable with multiple network enabled computer devices 135, 145, 155 associated with different categories of users such as venue users, mobile users, and business users. The connections between the network enabled computer devices 135, 145, 155 and the music tracking web server 100 over network 50 may be achieved using the aforementioned HTTP or HTTPS depending on the part of the music tracking website 110 with which a network enabled computer device 135, 145, 155 wishes to communicate.

The music tracking website 110 may include multiple components. The multiple components may include, for instance, a website management component 120, a venue component 130, a mobile/user component 140, a business component 150, a search engine component 152, and a push module 154.

The website management component 120 may comprise a software application operative on the processor component 105 that controls the administrative functions of the music tracking website 110. The website management component 120 may be generally arranged to manage the interfaces between the music tracking website 110 and other external components such as a network 50 (e.g., Internet) and multiple databases. For example, the music tracking website 110 may be communicable with a database server 160. The database server 160 may be communicable with the music tracking web server 100 over a local network connection or bus line and may include a venue database 170, a user database 175, a music database 180, and an application database 190. Communications with the venue database 170, user database 175, music database 180, and application database 190 may be performed by, for instance, a structured query language (SQL) interface. The embodiments are not limited to these examples.

The venue database 170 may store without limitation venue profile data, venue promotional data, and venue event data for registered venues of the music tracking website 110. The user database 175 may store without limitation user profile data for registered users of the music tracking website 110. The music database 180 may store without limitation songs played at various venues and requests for songs to be played at various venues. The songs may be stored along with additional data including, but not limited to, song name, artist name, venue name, venue location, date song played at venue, and time song played at venue. The application database 190 may store without limitation information pertaining to user registration such as login data, billing information, and user information such as contact data. The embodiments are not limited to these examples.

The website management component 120 may be further arranged to manage the music tracking website 110 accounts of end users and access by end users to the music tracking website 110. There may be two types or levels of music tracking website users—client users and website administrators. Website administrators may control information and services provided to the users on the protected 120 and public 115 parts of the music tracking website 110. Website administrators may collect information and generate reports pertaining to user activities such as subscriptions, payments, registrations, etc. Users may use the music tracking website 110 to subscribe to various services provided by the music tracking website 110. Users may be able to access a history of their operations and the current status of their subscriptions.

The website management component 120 may be further arranged to manage a user registration process. Registration may entail creating a private user identifier (ID)/password pair using a secure socket layer (SSL) protected website form that corresponds with the user. A registered user may login to the music tracking website 110 by providing their private user ID/password pair. A user's User ID and password may be stored in the application database 190.

The venue component 130 is another feature of the music tracking website 110 and may comprise a software application operative on the processor component 105 generally arranged to interact with venue devices 135 within venues that play music on a regular basis. A venue may be a bar or nightclub type establishment that plays music over a sound system.

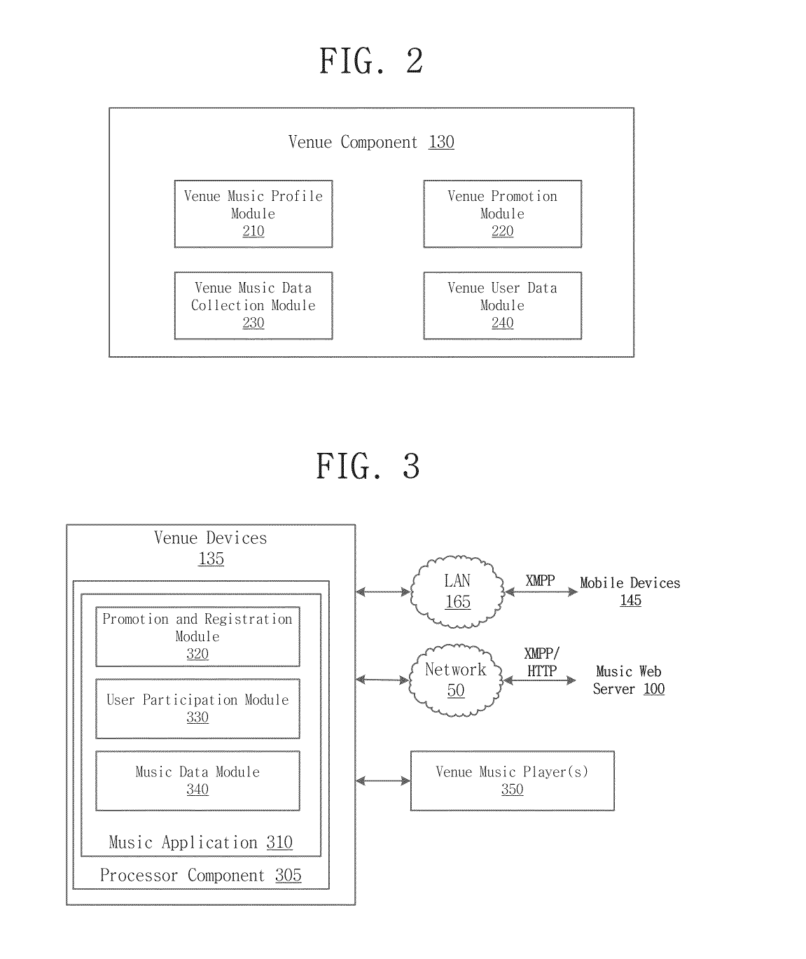

FIG. 2 illustrates an embodiment of a venue component 130 within the music tracking system 10. The venue component 130 may include software modules such as a venue music profile module 210, a venue promotion module 220, a venue music data collection module 230, and a venue user data module 240.

The venue music profile module 210 may collect profile data from a venue. The profile data may describe the genres of music most often played at the venue. For example, the venue music profile module 210 may receive data from a venue device 135 in response to a query registration form. The query registration form may be designed to elicit specific information about the venue pertaining to the genres of music most often played at the venue. This may further include whether the venue hosts live music shows. The venue profile data may be stored in the venue database 170. The venue data profile stored in the venue database 170 may be accessed by other modules in need of venue profile information.

The venue promotion module 220 may allow a venue to send promotional and registration information to the music tracking web site 110. The registration information may be used by the website management component 120 to establish and enroll the venue as an authorized user of and contributor to the music tracking website 110. The promotional information may be stored by the music tracking website 110 in the venue database 170 that is searchable by mobile users and other computer devices over network 50. Promotional information may include, but is not limited to, cover charge waivers, drink specials, special guests, etc.

The venue promotion module 220 may also collect event schedule data for each venue. The event schedule data may be indicative of events or activities scheduled at the venue for a defined period of time. The venue promotion module 220 may periodically receive updated event schedule information.

The venue music data collection module 230 may receive real-time updates of all songs that are played within the venue. For example, the venue music data collection module 230 may receive song by song updates from different venue devices 135 in different venues. Each update may include a song title, artist name, venue name, venue location, date, and time the song was played. In addition, the venue music data collection module 230 may receive any requests for songs that were made at the venue. The data pertaining to actually played songs and requested songs may then be written to and stored in the music database 180 where it may be accessed by the search engine component 152.

The venue user data module 240 may receive data from a venue device pertaining to mobile devices 145 that are connected to and interacting with the venue device 135. The interactions may include, for instance, mobile device feedback on the music played at the venue. This may include spontaneous feedback in the form of a “like” or “dislike” type indicator associated with a particular song in the playlist data, or a user rating or other feedback on a song in the playlist data. The embodiments are not limited to this example.

FIG. 3 illustrates an embodiment of a venue device 135 communicable with the music tracking system 10. Specifically, the venue device 135 may be communicable with the venue component 130 within the music tracking website 110. The venue device 135 may include a music application 310 operative on a processor component 305. The music application 310 may include software modules such as a promotion and registration module 320, a request module 330, and a music data module 340. The venue device 135 may be further communicable with one or more venue music player 350 to play music throughout the venue. The venue device 135 may also be coupled with network 50 to communicate with the music web server 100 and music tracking website 110. The venue device 135 may further be coupled with a local area network (LAN) 165. LAN 165 may be operated within and by the venue for the purpose of exchanging information with mobile devices 145 that are inside or nearby the venue.

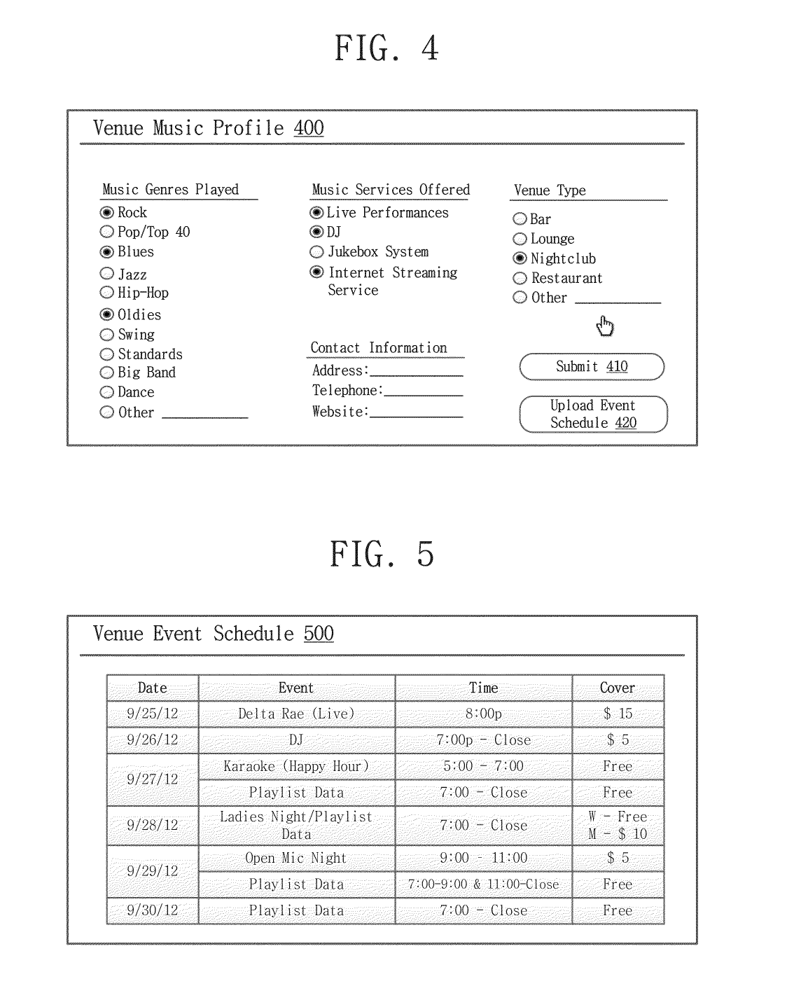

The promotion and registration module 320 may assist in registering the venue device with the music tracking website 110. This may entail creating an account by providing the website management component 120 for the music tracking website 110 the relevant information to create the account as described above. Once the venue is registered with the music tracking website 110, the promotion and registration module 320 may also be used to create a venue profile describing the music played at the venue. The process of creating a venue profile is described further with reference to FIG. 4 below. The promotion and registration module 320 may further be used to disseminate information regarding promotions or special events happening at the venue. For instance, a venue may be sponsoring an event such as a charity run after which there may be a special live show at the venue. This information may be uploaded over network 50 to the music tracking website 110 via the venue component 130 where it can be associated with the venue's profile contained in the venue database 170. When a mobile device 145 (or other requesting computer device) performs a search for the venue on the music tracking website 110 via search engine component 152, the promotional information along with the general venue profile may be displayed to the requesting device.

The user participation module 330 may be communicable with mobile devices 145 within the venue over LAN 165. The user participation module 330 may interact with mobile devices 145 present at the venue as well as the mobile/user component 140. For example, the user participation module 330 may accept requests for songs to be played. A mobile device 145 may submit a request to the venue device 135. The song request may be received and acted on by the venue device 135. This does not necessarily mean that the song will be played by the venue. For instance, the venue may only play the top three (3) most requested songs. In addition, song requests may be forwarded to the venue music data collection module 230 within the music tracking web site 110. The song request data may then be written to and stored along with song data for songs actually played in venues in the music database 180. FIGS. 10-12 below provide more detail on making song requests from a mobile device 145 or other requesting computer device.

The user participation module 330 may also interact with mobile devices 145 present at the venue to exchange data including recording a connection of a mobile device 145 to a venue device 135 or venue network 165 and data exchanges between the mobile device 145 and the venue device 135. Such data exchanges may include, for instance, mobile device feedback on the music played at the venue. This may include spontaneous feedback in the form of a “like” or “dislike” type indicator associated with a particular song in the playlist data, or a user rating or other feedback on a song in the playlist data.

This data may also include an indication of how many mobile devices are “connected” with the venue at any given moment. The user participation module 330 may also allow connected users to directly communicate with one another or post to a common location for connected users to comment on the venue or playlist over an instant messaging (IM) type application. The comments may be forwarded to and stored by the music tracking website 110 in the venue database 170. A venue may subsequently search for and access user posts/comments as a way to evaluate the customer experience at the venue and alter future music offerings accordingly. The embodiments are not limited to these examples.

The music data module 340 within venue device 135 may be responsible for communicating with the venue music data module 230 within the venue component 130 of music tracking website 110. The music data module 340 may keep track of all songs played at the venue. Each song may be associated with song data such as the name of the song and the name of the artist. In addition, each song played may be tagged with additional metadata such as the name of the venue, the location of the venue, the date the song was played and the time the song was played. Each of these data points may be forwarded in real-time to the venue music data module 230 over network 50 where it may then be written to the music database 180.

The music data module 340 may update the venue music data module 230 each time a new song is played allowing the music tracking website 110 to have real-time knowledge of songs playing at all registered venues. The music data module 340 may also track of all songs requested at the venue and forward this information to the venue music data module 230 over network 50 where it too may be written to the music database 180. Thus, the music database 180 comprises a constantly growing repository of all songs that have been played and/or requested at every registered venue.

FIG. 4 illustrates an embodiment of a computer screen image for entering data pertaining to a venue profile. The computer screen image may be labeled as a “Venue Music Profile” page 400 within music tracking website 110. The “Venue Music Profile” page 400 may be accessed by the promotion and registration module 330 of the venue device 135 communicating with the venue music profile module 210 of the venue component 130 over network 50. The “Venue Music Profile” page 400 within music tracking website 110 may present criteria in the form of buttons that include music genre selections. The venue device 135 may select one or more of the music genres to be associated with the venue. The music genre selections may include, but are not limited to, rock, pop/top 40, blues, jazz, hip-hop, oldies, swing, standards, big band, and dance. The embodiments are not limited to these examples.

The “Venue Music Profile” page 400 within music tracking website 110 may also present criteria in the form of buttons that include music services offered. The venue device 135 may select one or more of the music services offered to be associated with the venue. The music services offered may include, but are not limited to, whether the venue hosts live performances, utilizes a disc jockey (DJ) to play songs, utilizes a jukebox type system, or utilizes an internet streaming service (e.g., Pandora or Spotify™). The embodiments are not limited to these examples.

The “Venue Music Profile” page 400 within music tracking website 110 may further present criteria in the form of buttons that include the type of venue. The venue device 135 may select one or more of the venue types to be associated with the venue. The venue types may include, but are not limited to, bar, nightclub, lounge, restaurant, or space for the venue to input an “other” type. The embodiments are not limited to these examples.

In this case, the venue device 135 has selected “Rock”, “Blues”, and “Oldies” as the music genres most played at the venue. In addition, the venue has indicated that live music is played at the venue and also utilizes a DJ and Internet streaming services. The venue has also indicated that it is a “Nightclub” under the venue type criteria. The “Venue Music Profile” page 400 may also include an area that accepts text input pertaining to venue contact information such as an address, a telephone number, and a web address. The venue device 135 may click the “Submit” button 410 to send the venue profile data to the venue music profile module 210 over network 50 where it may be written to the venue database 170.

The “Venue Music Profile” page 400 may further include an “Upload Event Schedule” button 420. The “Upload Event Schedule” button 420, when clicked, may present the computer screen image 500 shown in FIG. 5 which is described in more detail below.

FIG. 5 illustrates an embodiment of a computer screen image for entering data pertaining to a venue event schedule. The computer screen image may be termed a “Venue Event Schedule” page 500 and may be presented when a venue device 135 clicks the “Upload Event Schedule” button 420 in FIG. 4. The “Venue Event Schedule” page 500 may provide for multiple columns of data to be input by the venue device 135. For example, the venue device may provide event information that includes the date of the event, a description of the event, a start time of the event, and a fee or cover charge for the event. The embodiments are not limited to this example.

In the example of FIG. 5, a six day period from September 25-30 has been uploaded. The events shown include a live performance by a band, a DJ, a karaoke night, a ladies night, and an “open mic” night. Each of these events may be associated with its date, start time, and a cover charge if any. When no specific event is described, a default event of “Playlist Data” may be listed to indicate that the venue supports and encourages users to interact with the venue and/or music tracking website 110 to obtain and comment on music played at the venue. The data may then be written to the venue database 170 and associated with the specific venue. When a search is performed on the venue, the upcoming event information may be displayed along with the venue's profile information and recent song playlist. More than one event may occur at a venue for a given date and/or time. For instance, a large venue may have many rooms in which separate events may occur simultaneously. In another example, a venue may host two events sequentially on the same date at different times. The embodiments are not limited to these examples.

Referring back to FIG. 1, the mobile/user component 140 is another feature of the music tracking website 110. The mobile/user component 140 may comprise a software application operative on the processor component 105 generally arranged to interact with mobile user devices 145.

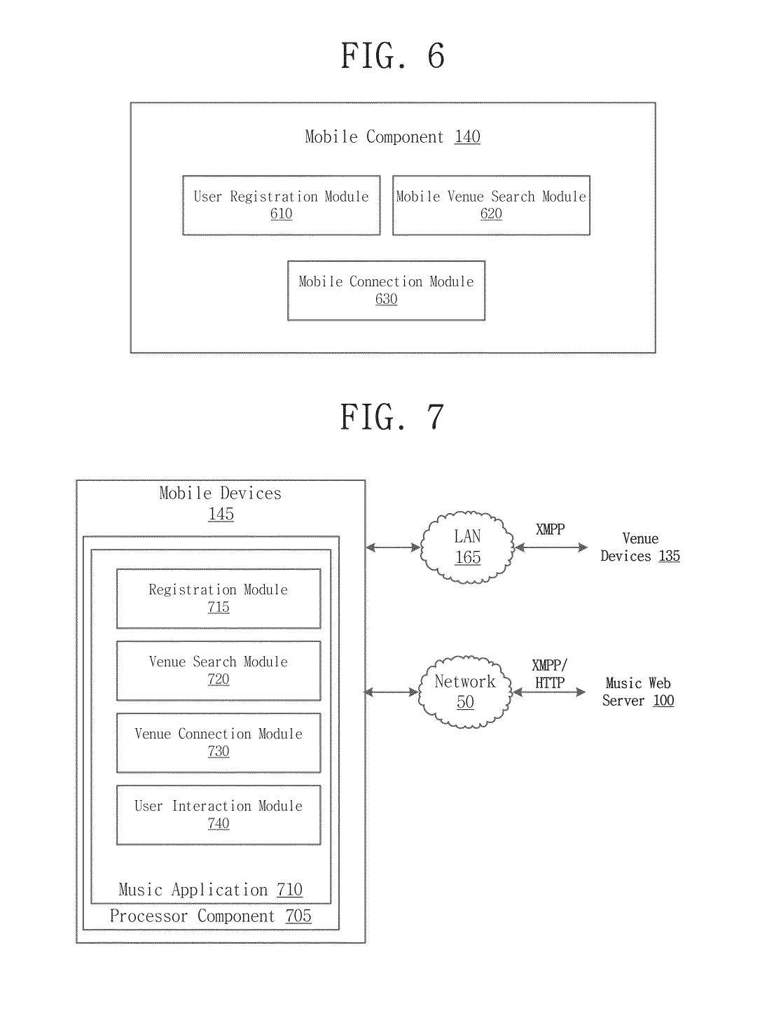

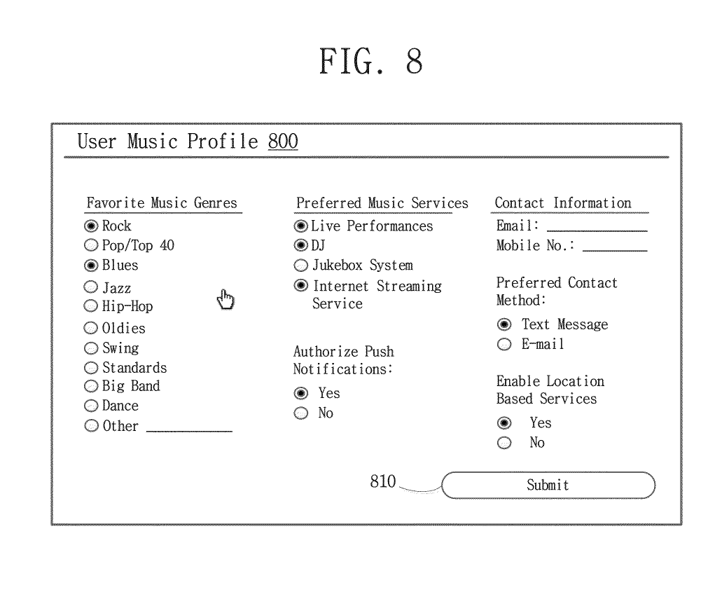

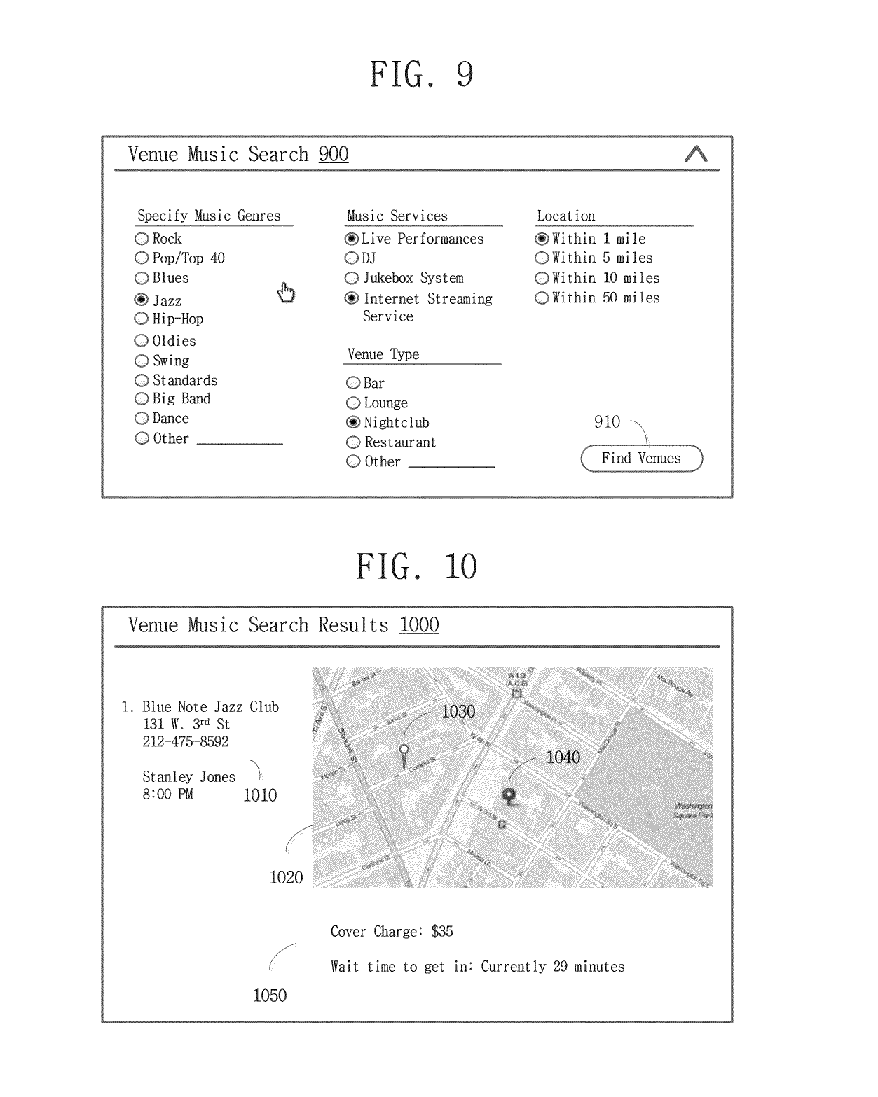

FIG. 6 illustrates an embodiment of a mobile/user component 140 within the music tracking system 10. The mobile/user component 140 may include software modules such as a user registration module 610 and a mobile venue search module 620. The user registration module 610 may receive registration and user profile information from mobile devices 145. The process for creating a user profile is described in more detail with reference to FIG. 8 below. The mobile venue search module 620 may receive requests for venue information from mobile devices 145. The requests for venue information may be geographic in nature, based on music genre, based on live music or any combination of the above. The process for requesting venue information is described in more detail with reference to FIGS. 9-10 below.

The mobile/user component 140 may further include a mobile connection module 630. The mobile connection module 630 may communicate with mobile devices 145 over the network 50 as previously described. The mobile connection module 630 and mobile devices 145 may exchange data with one another. The data exchanged may include song data detected by the mobile device 145 using a third party audio fingerprinting application such as, for instance, Shazam™ or GraceNote™.

For example, a mobile device 145 may upload song data to the mobile connection module 630 when at a venue that is not registered or currently active with the music tracking website 110. In this manner, the music tracking website may receive playlist data from one or more mobile devices 145 physically present at a venue. If multiple mobile devices 145 are sending this data (e.g., crowd sourcing), the mobile connection module 630 may then determine its accuracy by comparing the received song data from all of the mobile devices 145. So long as there is a threshold level of uniformity, the mobile connection module 630 may determine the information to be accurate and record the data in the music database 180.

In addition, if the mobile device 145 has enabled push notifications, the mobile connection module 630 may send notifications to the mobile device 145 concerning music events at nearby venues based on a proximity and a profile match between the user of the mobile device 145 and a venue.

The mobile connection module 630 may push promotional information for a particular venue to a mobile device 145 once it is determined that a mobile device is present at that particular venue. The mobile connection module 630 may also receive feedback data from the mobile device 145 pertaining to music services happening at the venue or related to the venue in general. In this manner, the music tracking website 110 may remain involved in data exchanges between a venue and a mobile device 145.

FIG. 7 illustrates an embodiment of a mobile device 145 communicable with the music tracking system 10. Specifically, the mobile device 145 may be communicable with the mobile/user component 140 within the music tracking website 110 over network 50. The mobile device 145 may include a music application 710 operative on a processor component 705. The music application 710 may include software modules such as a registration module 715, a venue search module 720, a venue connection module 730, and a user interaction module 740. The mobile device 145 may also be coupled with network 50 to communicate with the music web server 100. The mobile device 145 may further be coupled with a local area network (LAN) 165. LAN 165 may be operated within and by a venue for the purpose of exchanging information between mobile devices 145 that are inside or nearby the venue and a venue device 135.

The registration module 715 of a mobile device 145 may be used to create an account with the music tracking website 110. The registration module 715 may be communicable with the user registration module 610 of the mobile/user component 140 of the music tracking website 110. The registration module 715 may assist a user in creating an account with the music tracking website 110 and providing a user music profile to be associated with the user's account. The process for creating a user profile is described in more detail with reference to FIG. 8 below.

The venue search module 720 of a mobile device 145 may be used to search for and find compatible venues. The process for requesting venue information is described in more detail with reference to FIGS. 9-10 below.

The venue connection module 730 of a mobile device 145 may be used to establish a connection with a venue for purposes of interacting and exchanging data with a venue device 135 over LAN 165. The venue connection module 730 of a mobile device 145 may communicate directly with a venue device to post comments, provide feedback, respond to polls, make requests, rate songs, receive playlist data, etc. The venue device 135 may, in turn, forward data exchanges between mobile devices and venue devices to the venue user data module 240 within the music tracking website 110 where it may be stored and processed to help modify and refine user and venue profiles.

For example, user feedback on particular songs may reinforce a user's self-reported initial music profile. Or, the user feedback may indicate an evolution towards other genres of music that may cause the user music profile to change. The music tracking website 110 may tailor future push notifications to a mobile device 145 taking into account a perceived shift in the user's music profile to recommend venues and events that skew toward the new user music profile. The embodiments are not limited to these examples.

The user interaction module 740 of a mobile device 145 may be used to establish a connection with the mobile connection module 630 for purposes of interacting and exchanging data with the music tracking web site 110 over network 50. The mobile/user component 140 within music tracking website 110 may record and log a connection between a mobile device 145 and a venue. The mobile/user component 140 within music tracking website 110 may then return a message to the connected mobile device indicating how many other mobile devices 145 are connected with the same venue and available for communication. Each time a new mobile device connects with or drops from the venue, the mobile/user component 140 may send an update to all connected mobile devices 145. To avoid constant interruptions, the update may occupy a small part of the display for the music application 710. In its simplest form, a periodically updated number representing the number of connected users may be presented in the aforementioned part of the display.

The mobile/user component 140 within music tracking website 110 may also receive other data from venue devices 135 pertaining to interactions it has with mobile devices 145. These interactions may include data exchanges between the mobile device 145 and the venue device 135. Such data exchanges may include, for instance, mobile device feedback on the music played at the venue. This may include spontaneous feedback in the form of a “like” or “dislike” indicator associated with a particular song in the playlist data, or a user rating on a song in the playlist data. The embodiments are not limited to these examples.

In addition, the music application 710 may include an audio detection feature that can determine and log data such as how loud it is in the venue (e.g., ambient noise), how crowded it is based on the amount of voices detected, temperature, how bright it is—by using the mobile device's camera if it is so equipped. This information may be uploaded to the mobile connection module 630 within the music tracking website 110 and associated with the particular venue. The information may provide an ambience indicator to give more context to the atmosphere at the venue. This data may be presented to a user along with search results as later described in FIGS. 9-10. In this way, a user may be able to determine if a ‘found’ venue is too crowded or perhaps not crowded enough before determining whether to go to the venue.

The music application 710 in mobile device 145 may also provide wait times for getting into a particular venue. For example, an “Arrived” indicator may be activated on the mobile device 145 via the music application 710 when a user gets on line to get into a venue. When that user actually gets into the venue, a “Just Entered”. In this way, the wait times for getting into venues may also be recorded and presented along with venue search results. This additional data adds even more context to the atmosphere at the venue and further may shape a user's decision to go to the venue.

The arrival and entry feature may also be automated and tied to a location based services feature such as, for example, global positioning satellite (GPS) or radio frequency identification (RFID) tagging. GPS may determine when a mobile firat encounters a predetermined distance from the venue and may also determine when the mobile device 145 is within the venue. RFID tagging may trigger a first “arrival” signal outside the venue and a second “entered” signal within the venue near one or more venue entry points.

The music application 710 in mobile device 145 may also allow the user to enter comments such as the cover charge, whether a bouncer is admitting anyone or only certain people, etc. This data may then uploaded to the mobile connection module 630 within the music tracking website 110 and associated with the particular venue when search results are returned.

FIG. 8 illustrates an embodiment of a computer screen image for entering data pertaining to a user music profile. The computer screen image may be termed a “User Music Profile” page 800. The “User Music Profile” page 800 may be accessed by the registration module 715 of the mobile device 145 communicating with the user registration module 610 of the mobile/user component 140 over network 50. The “User Music Profile” page 800 within music tracking website 110 may present criteria in the form of buttons that include music genre selections, preferred music services, and location selections. The mobile device 145 may select one or more of the music genres to indicate the user's favorite music genres. The music genre selections may include, but are not limited to, rock, pop/top 40, blues, jazz, hip-hop, oldies, swing, standards, big band, and dance. The preferred music services buttons allow the mobile device 145 to indicate the type of music sought in this search. This may include, but is not limited to, live performances, a DJ, a jukebox, or an Internet streaming service. The contact information section allows the user to enter an email address, a mobile number or both. The “User Music Profile” page 800 may also query whether the user prefers to be contacted via email or text message (or both). In this example, the user has indicated a preference for text messages. The “User Music Profile” page 800 may also query whether the user agrees to receive push notifications from the music tracking website 110. In this example, the user has agreed to receive push notifications from the music tracking website 110 as indicated by the mark in the “Yes” button. The “User Music Profile” page 800 may further query whether the user agrees to enable location based services from the music tracking website 110. In this example, the user has agreed to enable location based services from the music tracking website 110 as indicated by the mark in the “Yes” button. Upon completing the query form of the “User Music Profile” page 800, the user may click the submit button 810 to send the user profile data to the user registration module 610 of the mobile component 140 over network 50. The user profile data may then be written to and stored in the user database 175.

Location based services may depend on whether the mobile device 145 can forward its current location to the music tracking website 110. In order to forward location information, the mobile device 145 would possess some type of location detection system. For instance, the mobile device 145 may be arranged to detect a location for the mobile computing device 145. The location detection system may comprise or be implemented using any particular location detection device or technique, such as an accelerometer, a gyroscope, a global positioning system (GPS), a network enhanced global positioning system, a base station proximity system, a triangulation system, a time difference system, a camera, a proximity sensor, and so forth. The location detection system may be suitable for use with different map systems, such as a navigation system for a vehicle. The location detection system may determine a current position for the mobile computing device 145, and in some cases, a predicted position for the mobile computing device 145 based on velocity and direction information.

Once a user has registered, the music tracking website 110 may initiate certain actions for each registered user. This is especially true if the user has authorized push notifications and location based services. For instance, a user may be approaching a venue that is also registered with the music tracking website 110. The venue profile for the venue in venue database 170 may have a strong correlation to the user's music profile in the user database 175. The mobile device 145 may be providing location data to the music tracking website 110. The music tracking website 110 may process the received location data from the mobile device 145 using search engine component 152 to locate venues in the venue database 170 that are very near the user's current location based on the address data contained in the venue profiles. The venue profiles of any venues in the venue database 170 that are nearby may be compared to the user's music profile contained in the user database 175. If there is a strong enough correlation between the venue music profile and the user's music profile, the push notification component 154 may construct an email or a text message describing the nearby venue. The method of communication with the user may depend on the preferred method of communication identified by the user when setting up the account. As an example, the push notification component 154 may construct and send a text message that reads “You are approaching ‘National Underground’ ahead. This venue matches your user music profile. Click on the link to obtain more information about this venue.” If the user clicks the link, the full venue profile may be displayed on the user's mobile device 145. The embodiments are not limited to this example.

In another example, the user may keep a favorites list of several venues. The push notification module 154 may push messages pertaining to those venues to the mobile device 145 each time a new update for one of the venues is received by the music tracking website 110.

In yet another example, a user may have a favorite venue. The user may open a link to that venue's venue profile. The venue profile may further include a link to the most recently played songs. The user may click this link to receive a live playlist that includes the current song being played at the venue as well as the last five, ten, twenty, etc. songs that were played. The user may then create a playlist on his/her own device importing the venue playlist data into their own stored music application. The user may then play the playlist wherever they are (e.g., a house party) to simulate the music experience of the venue.

Once the user has self-created his or her own music profile, the mobile connection module 630 of the music tracking website 110 may use data subsequently received pertaining to the user to modify or alter the user's music profile. The data may include a history of venue searches, a history of venues visited, a history of music requested, a history of songs rated, a mining of user feedback or comments posted, etc. The actual historical data just mentioned may indicate a shift away from certain aspects of the initial self-created music profile. For example, the self-created user music profile may have not have identified jazz as a favorite music genre. However, the user's recent history may include several visits to jazz clubs and requests for jazz songs as well as positive feedback of other jazz songs. The mobile connection module 630 may then update the user's music profile to include jazz as a favorite genre. Subsequent actions by the music tracking website 110 may then factor in jazz for that user. This may include the music tracking website 110 recommending venues, songs, artists and the like to the user. Thus, the user's own history may show an evolution toward a new music profile. The embodiments are not limited to these examples.

Referring back to FIG. 7, the venue search module 720 may be used to locate a particular venue. FIG. 9 illustrates an embodiment of a computer screen image for entering data pertaining to a venue search. The computer screen image may be termed a “Venue Music Search” page 800. The “Venue Music Search” page 900 may be accessed by the venue search module 730 of the mobile device 145 communicating with the mobile venue search module 620 of the mobile component 140 over network 50. The “Venue Music Search” page 900 within music tracking website 110 may present criteria in the form of buttons that include music genre selections. The mobile device 145 may select one or more of the music genres to be associated with a venue search. The music genre selections may include, but are not limited to, rock, pop/top 40, blues, jazz, hip-hop, oldies, swing, standards, big band, and dance.

The “Venue Music Search” page 900 within music tracking website 110 may also present criteria in the form of buttons that include music services offered. The mobile device 145 may select one or more of the music services offered to be associated with the venue search. The music services offered may include, but are not limited to, whether the venue hosts live performances, utilizes a disc jockey (DJ) to play songs, utilizes a jukebox type system, or utilizes an internet streaming service. The embodiments are not limited to these examples.

The “Venue Music Search” page 900 within music tracking website 110 may further present criteria in the form of buttons that include the type of venue. The mobile device 145 may select one or more of the venue types to be associated with the venue search. The venue types may include, but are not limited to, bar, nightclub, lounge, restaurant, or space for the venue to input an “other” type. The embodiments are not limited to these examples.

The “Venue Music Search” page 900 within music tracking website 110 may also present criteria in the form of buttons that include location selections. The location buttons will provide search results that are constrained to certain specified distances. The “Venue Music Search” page 900 may also be reached from a stationary computer device such as a desktop PC or laptop as well. The embodiments are not limited to these examples.

In the example of FIG. 9, the mobile device 145 may have specified that its user is searching for a nightclub playing live jazz or is streaming jazz that is within one mile of the current location of the mobile device 145. The mobile device 145 may click the “Find Venues” button 910 to send the request along with a location identifier of the requesting device to the mobile venue search module 610 of the mobile component 130 over network 50 where it can be processed. The request may be received and processed by the search engine component 152. The search engine component 152 may access the venue database 170 to locate venue profiles that match the request. The venue profiles that match the request may then be formatted into a search results page and returned to the requesting device (e.g., mobile device 145). The embodiments are not limited to this example.

FIG. 10 illustrates an embodiment of a computer screen image for showing results pertaining to a venue music search. The computer screen image may be termed a “Venue Music Search Results” page 1000. The “Venue Music Search Results” page 1000 may be generated by the mobile venue search module 610 of the mobile component 130 within music tracking website 110. The mobile venue search module 610 may receive the search request and access the venue database 170 to search for a match based on venue profiles and a current event listing for the venues. In the example of FIG. 10, the “Venue Music Search Results” page 1000 indicates that there is one venue that fits the desired criteria. The “Venue Music Search Results” page 1000 may present the results by providing a text portion 1010 that details the name, address, and telephone number of the venue as well as the name of the artist performing live. The “Venue Music Search Results” page 1000 may also present a map of the current location of the mobile device 1030 and the location of the venue 1040 to give a visual indication of where the venue is and how to get there. The search results may also include other informative data 1050 such as the cover charge and the current wait times. This data may be supplied by the venue itself or may have been determined from data collected by mobile devices 145 physically present at the venue. In addition, the name of the venue may be a hyperlink that, when clicked, opens a webpage for the venue on which the mobile user may obtain additional information about the venue and the live show playing that evening.

Referring back to FIG. 7, the venue connection module 730 may be used to make a song request within a venue. The venue connection module 730 may be communicable with a venue device 135 within the venue over LAN 165. The venue connection module 730 may send requests for songs to be played to the user participation module 330 within a venue device 135. The song request may be received and acted on by the venue device 135. This does not necessarily mean that the song will be played by the venue.

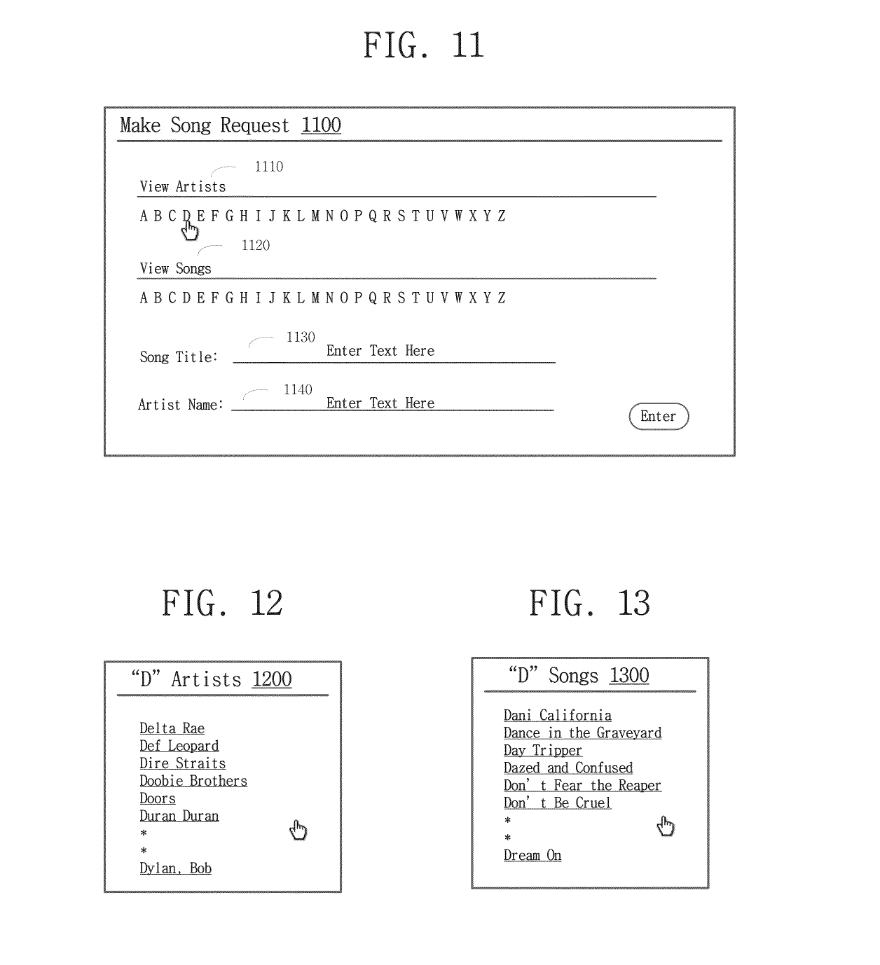

FIG. 11 illustrates an embodiment of a computer screen image for entering data pertaining to a song request. The computer screen image may be termed a “Make Song Request” page 1100. The “Make Song Request” page 1100 may be accessed by the venue connection module 730 of the mobile device 145 communicating with the user participation module 330 of the venue device 135 over LAN 165. The “Make Song Request” page 1100 within the user participation module 330 of the venue device 135 may present multiple methods to search for a song. These methods may include searching by artist 1110, searching by song title 1120, specifically inputting a song title 1130, and specifically inputting an artist name. The embodiments are not limited to this example.

The mobile device 145 may decide to search by artist 1110 by selecting a letter corresponding to the name of the artist. The mobile device 145 may decide to search by song title 1120 by selecting a letter corresponding to the title of the song. The mobile device 145 may decide to specifically input a song title 1130 or an artist 1140. Upon clicking “enter”, the request may be sent to the user participation module 330 of the venue device 135 over LAN 165. The user participation module 330 of the venue device 135 can then perform a search based on the request and provide results back to the mobile device 145. The embodiments are not limited to this example.

FIG. 12 illustrates another embodiment of a computer screen image 1200 for entering data pertaining to an artist. The computer screen image may be termed a “D Artists” page 1200. For example, if the mobile device 145 selected the letter “D” under the “View Artists” 1010 option, the “D Artists” page 1200 may be returned. The mobile device 145 may then peruse the returned list to select a specific artist. Once that artist is selected by clicking on, for instance, a hyperlink, a list (not shown) of all songs accessible to the venue by that artist may be displayed. In addition, the search results may include recommendations of other artists that are similar to the selected artist. These additional artists may be presented with a tag line to the effect “If you like X then you may like these artists too” before listing the similar artists. The mobile device 145 may then select one of the songs to complete the request or peruse one of the recommended artists. The embodiments are not limited to this example.

FIG. 13 illustrates another embodiment of a computer screen image 1300 for entering data pertaining to a song. The computer screen image may be termed a “D Songs” page 1300. For example, if the mobile device 145 selected the letter “D” under the “View Songs” 1020 option, the “D Songs” page 1300 may be returned. The mobile device 145 may then peruse the returned list to select a specific song. In addition, the search results may include recommendations of other songs that are similar to the selected song. These additional songs may be presented with a tag line to the effect “If you like X then you may like these songs too” before listing the similar songs. The mobile device 145 may then select one of the songs to complete the request. The embodiments are not limited to this example.

If the mobile device 145 opted to input a specific “Song Title” 1130, the user participation module 330 of the venue device 135 can then perform a search for the specifically requested song and provide results back to the mobile device 145. The results may include multiple options for the song if it has been performed by multiple artists or includes multiple versions (e.g., studio version and live version). In addition, the search results may include recommendations of other songs that are similar to the selected song. These additional songs may be presented with a tag line to the effect “If you like X then you may like these songs too” before listing the similar songs. The mobile device 145 may then peruse the returned list to select a specific song. The mobile device 145 may then select one of the songs to complete the request. The embodiments are not limited to this example.

If the mobile device 145 opted to input a specific “Artist Name” 1140, the user participation module 330 of the venue device 135 can then perform a search for the specifically requested artist and provide results back to the mobile device 145. All songs accessible to the venue by that artist may be displayed. In addition, the search results may include recommendations of other artists that are similar to the selected artist. These additional artists may be presented with a tag line to the effect “If you like X then you may like these artists too” before listing the similar artists. The mobile device 145 may then select one of the songs to complete the request or peruse one of the recommended artists. The embodiments are not limited to this example.

Referring back to FIG. 1, the business user component 150 is another feature of the music tracking website 110. The business user component 150 may comprise a software application operative on the processor component 105 generally arranged to interact with business user devices 155.

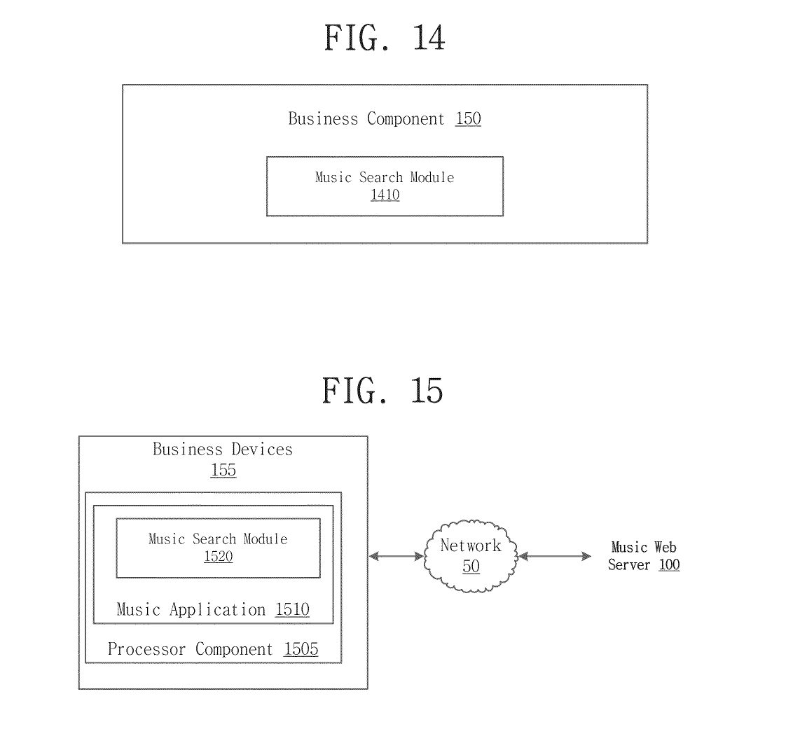

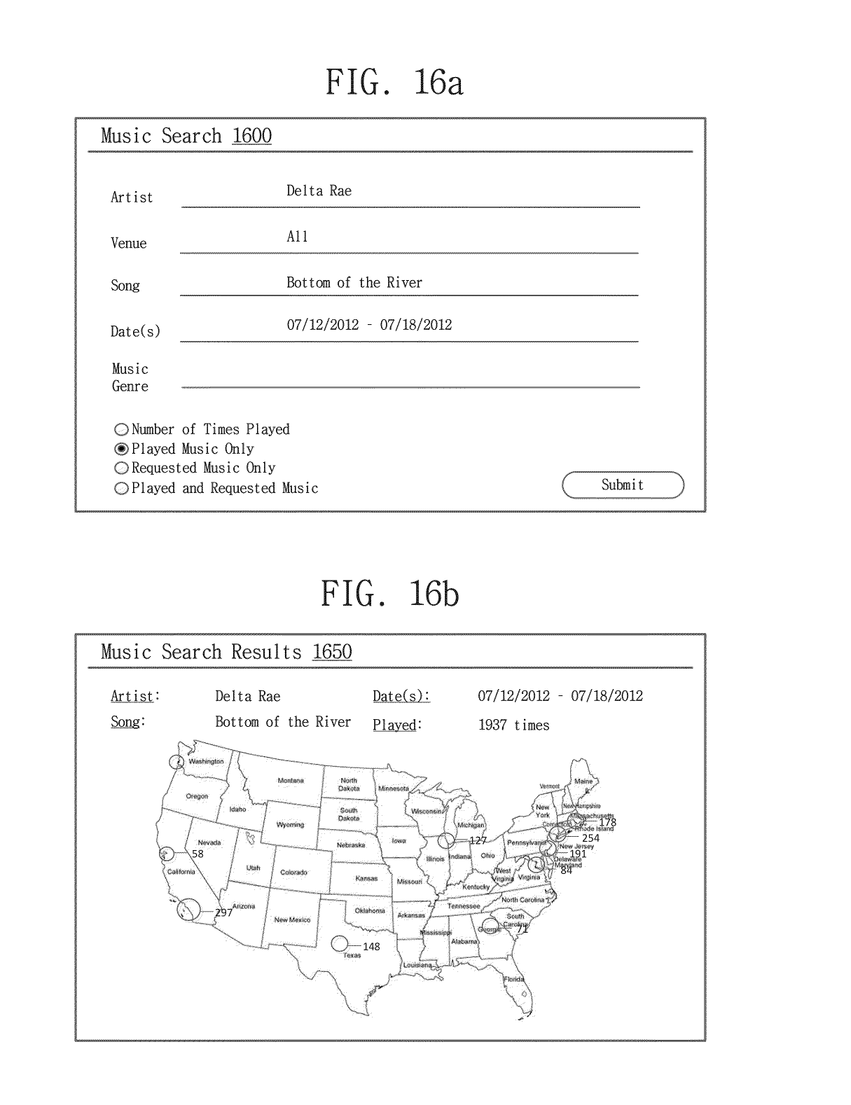

FIG. 14 illustrates an embodiment of a business user component 150 within the music tracking system 10. The business component 150 may include a software module such as a music search module 1410. The music search module 1410 may receive requests for music information from business devices 155. A business device 155 may be a mobile device such as a smartphone or tablet computer. A business device 155 may also be a laptop or desktop computer. A business device is generally any computing device that can be coupled with the network 50 and access the music tracking website 110. A business device 155 may be used to query or search the music database 180 associated with the music tracking website 110. Music searches may be based on artist, song, venue, date or any combination of the above. The process for performing a music search is described in more detail with reference to FIG. 16 below.

FIG. 15 illustrates an embodiment of a business user device 155 communicable with the music tracking system 10. Specifically, the business device 155 may be communicable with the business component 150 within the music tracking website 110. The business device 155 may include a music application 1510 operative on a processor component 1505. The music application 1510 may include a software module such as a music search module 1510. The mobile device 145 may also be coupled with network 50 to communicate with the music web server 100. The music search module 1410 may be used to perform specific database queries of the music database 180 associated with the music tracking website 110. More specifically, the music search module 1410 may forward music search queries to the search engine component 152. The search engine component 152 may then process the music search queries against the music database 180.

FIG. 16a illustrates an embodiment of a computer screen image for entering data pertaining to a music search. The computer screen image may be termed a “Music Search” page 1600. The “Music Search” page 1600 may be accessed by the music search module 1520 of the business device 155 communicating with the music search module 1410 of the business component 150 within the music tracking website 110 over network 50. The “Music Search” page 1600 may present multiple parameters to search for song data. These parameters may include artist, venue, song, date, music genre, number of times played and whether to include played music, requested music, or both. The embodiments are not limited to this example.

In the example shown in FIG. 16a, the business device 155 has input the name “Delta Rae” as the artist, the song title “Bottom of the River”, a date range of Jul. 12, 2012 through Jul. 18, 2012, and that only played instances should be returned in the results. The request has further indicated that all venues should be searched. The music search query may then be sent over network 50 to the music search module 1410 within music tracking website 110. The music search query may be forwarded to the search engine component 152. The search engine component 152 may then process the music search queries against the music database 180.

The results of this search may be illustrated in FIG. 16b. FIG. 16b illustrates a “Music Search Results” page 1650. In this example, the “Music Search Results” page 1650 includes the total number of times the song “Bottom of the River” by Delta Rae was played at all venues during the week of Jul. 12, 2012 to Jul. 18, 2012. The results may, for instance be plotted on a map to give a visual indication of where the song is more popular. Here, a map of the United States shows the top ten regions where the song was played during the time period specified. In addition, while not shown, the results could list each venue separately and the number of times each venue played the song. Moreover, the results may be presented textually, graphically or both. This particular request may be initiated from the band itself to see if their new single is being played, where, and how often. It should be noted that standard database techniques may be used to search for, aggregate, and present results. The embodiments are not limited to this example.

In another example, a licensing agency may wish to see what songs a particular venue played during a particular week. The licensing agency may form a query that specifies the criteria of venue name and date range. Since no song title or artist name is included in the query, the results will include all songs and artist names played at the specified venue during the specified date range.

In still another example, an industry tracking group may wish to publish a chart of the top requested songs for a particular week. The industry tracking group may form a query that specifies the criteria of number of times played only. The search results may return a ranked list of song titles and artists according to the number of times the song title was played during the date range. The query may further be limited to returning only the top five, top ten, top forty, top one hundred, etc. The embodiments are not limited to these examples.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

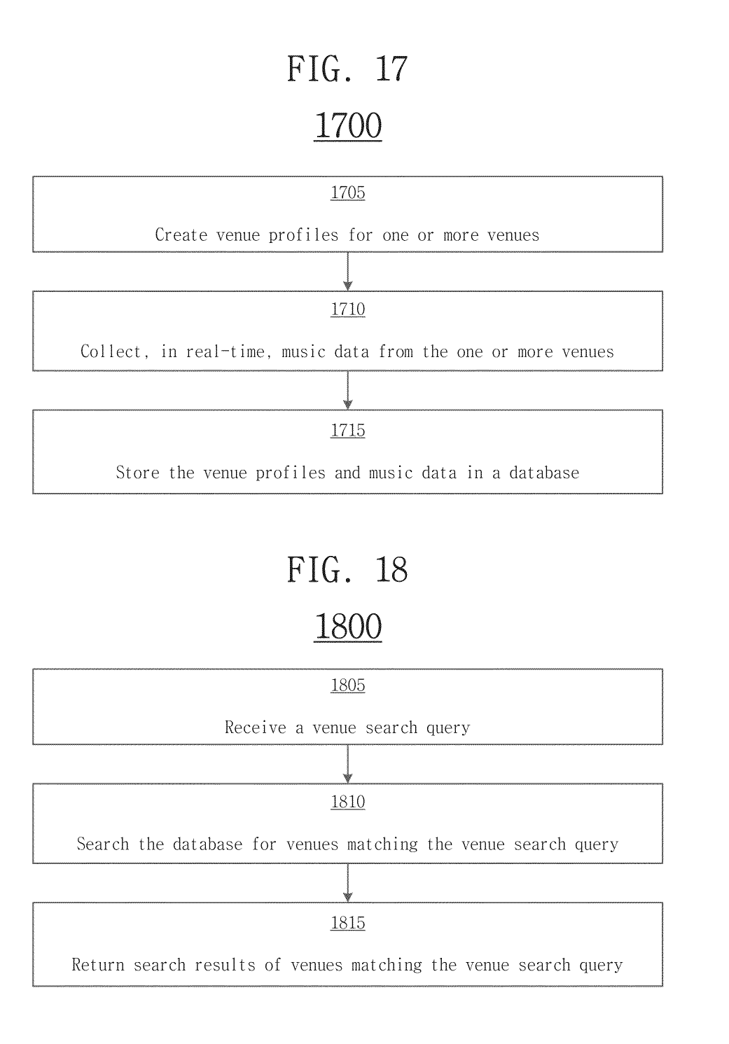

FIG. 17 illustrates one embodiment of a logic flow 1700. The logic flow 1700 may be representative of some or all of the operations executed by one or more embodiments described herein.

In the illustrated embodiment shown in FIG. 17, the logic flow 1700 may create venue profiles for one or more venues at block 1705. For example, the venue music profile module 210 within the venue component 130 of the music tracking website 110 may create the venue profiles for one or more venues. A venue profile may comprise a venue name, venue address, and one or more music genres indicative of the type of music played at the venue. The venue profile may further comprise an upcoming event schedule indicative of music related events scheduled at the one or more venues as well as telephone contact data for the venue, a website address for the venue, and an indication whether the venue plays live music. The venue profile may be sent from the promotion and registration module 320 of a venue device 135 over the network 50 to the venue music profile module 210 within the venue component 130 of the music tracking website 110. The embodiments are not limited to these examples.

In the illustrated embodiment shown in FIG. 17, the logic flow 1700 may collect, in real-time, music data from the one or more venues at block 1710. For example, the venue music data collection module 230 within the venue component 130 of the music tracking website 110 may collect, in real-time, music data from the one or more venues. The music data may comprise venue data, a song title, an artist name, and a date. The music data may be indicative of music played at the one or more venues. The music data may be sent in real-time from the music data module 340 of a venue device 135 over the network 50 to the venue music data collection module 230 within the venue component 130 of the music tracking website 110. The embodiments are not limited to these examples.

In the illustrated embodiment shown in FIG. 17, the logic flow 1700 may store the venue profiles and music data in a database at block 1715. For example, the venue music data collection module 230 within the venue component 130 of the music tracking website 110 may receive the music data and write it to the music database 180. Similarly, the venue music profile module 210 within the venue component 130 of the music tracking website 110 may receive the venue profiles and write them to the venue database 170. The embodiments are not limited to these examples.

FIG. 18 illustrates one embodiment of a logic flow 1800. The logic flow 1800 may be representative of some or all of the operations executed by one or more embodiments described herein.

In the illustrated embodiment shown in FIG. 18, the logic flow 1800 may receive a venue search query at block 1805. For example, the mobile venue search module 620 within the mobile component 140 of the music tracking website 110 may receive the venue search query specifying criteria including a music genre and a distance limiter relative to a location. The venue search query may be sent from the request module 730 of a requesting device such as a mobile device 135 or other networked computer device over the network 50 to the mobile venue search module 620 within the mobile component 140 of the music tracking website 110. The embodiments are not limited to these examples.

In the illustrated embodiment shown in FIG. 18, the logic flow 1800 may search a database for venues matching the venue search query at block 1810. For example, the mobile venue search module 620 within the mobile component 140 of the music tracking website 110 may search the venue database 170 for one or more venues located within the distance limiter. In addition, the music genre specified in the music venue query in its venue profile must also match the venue search query criteria. The embodiments are not limited to these examples.

In the illustrated embodiment shown in FIG. 18, the logic flow 1800 may return the search results at block 1815. For example, the mobile venue search module 620 within the mobile component 140 of the music tracking website 110 may return the search results of venues matching the venue search query criteria to the requesting device over the network 50. The embodiments are not limited to these examples.

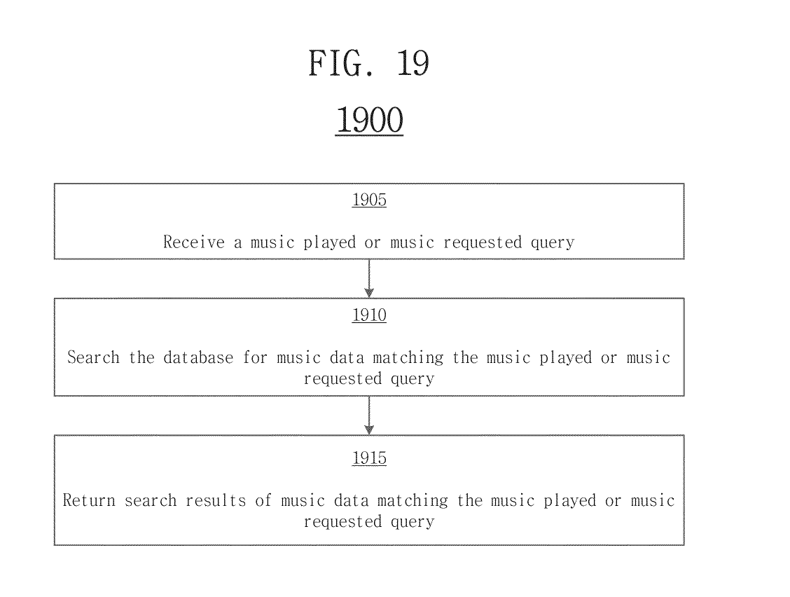

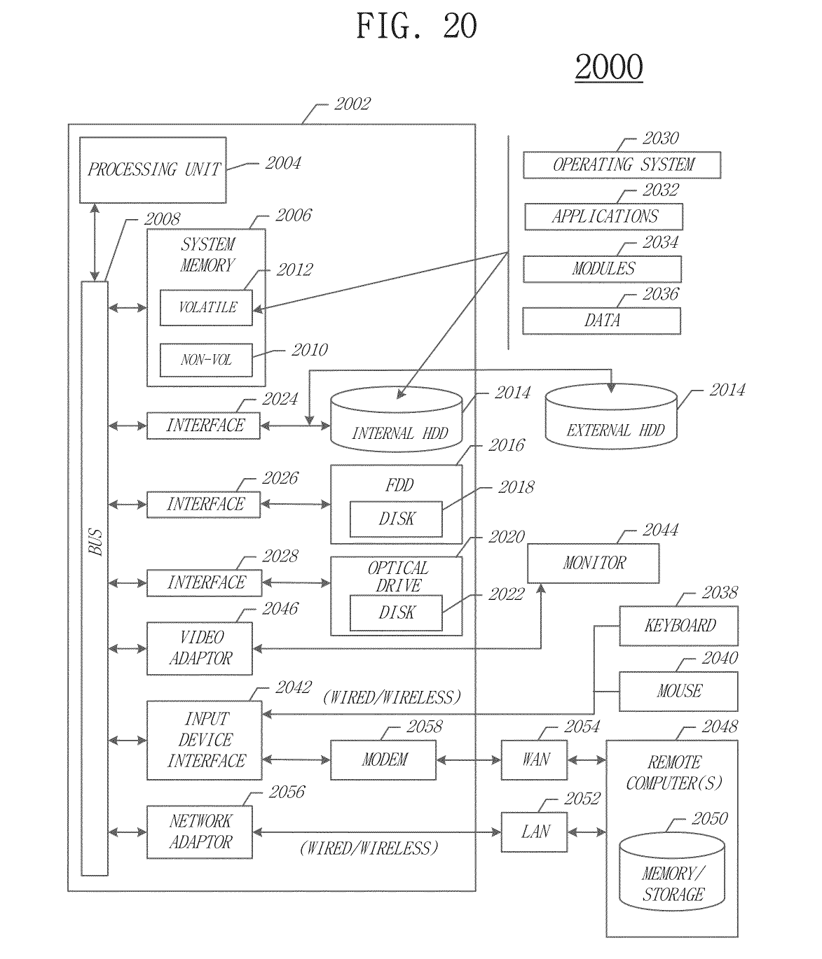

FIG. 19 illustrates one embodiment of a logic flow 1900. The logic flow 1900 may be representative of some or all of the operations executed by one or more embodiments described herein.

In the illustrated embodiment shown in FIG. 19, the logic flow 1900 may receive a music played and/or a music requested query at block 1905. For example, the music search module 1410 within the business component 150 of the music tracking website 110 may receive the music played and/or a music requested query specifying criteria including a date range and at least one of an artist name, a song title, and a venue. The music played and/or a music requested query may be sent from the music search module 1520 of a requesting device such as a business device 155 over the network 50 to the music search module 1410 within the business component 150 of the music tracking website 110. A business device 155 may be a mobile device, a tablet device, or other networked computer device. The embodiments are not limited to these examples.

In the illustrated embodiment shown in FIG. 19, the logic flow 1900 may search a database for music data matching the music played and/or music requested query criteria at block 1910. For example, the music search module 1410 within the business component 150 of the music tracking website 110 may search the music database 190 for music data that matches the query criteria. The embodiments are not limited to these examples.

In the illustrated embodiment shown in FIG. 19, the logic flow 1900 may return the search results at block 1915. For example, the music search module 1410 within the business component 150 of the music tracking website 110 may return the search results of music data matching the music played and/or music requested query criteria to the business device 155 over the network 50. The embodiments are not limited to these examples.

FIG. 20 illustrates an embodiment of an exemplary computing architecture 2000 suitable for implementing various embodiments as previously described. In one embodiment, the computing architecture 2000 may comprise or be implemented as part of an electronic device. The embodiments are not limited in this context.

As used in this application, the terms “system” and “component” are intended to refer to a computer-related entity, either hardware, a combination of hardware and software, software, or software in execution, examples of which are provided by the exemplary computing architecture 2000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 2000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 2000.

As shown in FIG. 20, the computing architecture 2000 comprises a processing unit 2004, a system memory 2006 and a system bus 2008. The processing unit 2004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 2004.

The system bus 2008 provides an interface for system components including, but not limited to, the system memory 2006 to the processing unit 2004. The system bus 2008 can be any of several types of bus structure that may further interconnect to a memory bus (with or without a memory controller), a peripheral bus, and a local bus using any of a variety of commercially available bus architectures. Interface adapters may connect to the system bus 2008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 2000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 2006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 20, the system memory 2006 can include non-volatile memory 2010 and/or volatile memory 2012. A basic input/output system (BIOS) can be stored in the non-volatile memory 2010.

The computer 2002 may include various types of computer-readable storage media in the form of one or more lower speed memory units, including an internal (or external) hard disk drive (HDD) 2014, a magnetic floppy disk drive (FDD) 2016 to read from or write to a removable magnetic disk 2018, and an optical disk drive 2020 to read from or write to a removable optical disk 2022 (e.g., a CD-ROM or DVD). The HDD 2014, FDD 2016 and optical disk drive 2020 can be connected to the system bus 2008 by a HDD interface 2024, an FDD interface 2026 and an optical drive interface 2028, respectively. The HDD interface 2024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 2010, 2012, including an operating system 2030, one or more application programs 2032, other program modules 2034, and program data 2036. In one embodiment, the one or more application programs 2032, other program modules 2034, and program data 2036 can include, for example, the various applications and/or components of the system 100.

A user can enter commands and information into the computer 2002 through one or more wire/wireless input devices, for example, a keyboard 2038 and a pointing device, such as a mouse 2040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 2004 through an input device interface 2042 that is coupled to the system bus 2008, but can be connected by other interfaces such as a parallel port, IEEE 1394 serial port, a game port, a USB port, an IR interface, and so forth.

A monitor 2044 or other type of display device is also connected to the system bus 2008 via an interface, such as a video adaptor 2046. The monitor 2044 may be internal or external to the computer 2002. In addition to the monitor 2044, a computer typically includes other peripheral output devices, such as speakers, printers, and so forth.

The computer 2002 may operate in a networked environment using logical connections via wire and/or wireless communications to one or more remote computers, such as a remote computer 2048. The remote computer 2048 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2050 is illustrated. The logical connections depicted include wire/wireless connectivity to a local area network (LAN) 2052 and/or larger networks, for example, a wide area network (WAN) 2054. Such LAN and WAN networking environments are commonplace in offices and companies, and facilitate enterprise-wide computer networks, such as intranets, all of which may connect to a global communications network, for example, the Internet.

When used in a LAN networking environment, the computer 102 is connected to the LAN 2052 through a wire and/or wireless communication network interface or adaptor 2056. The adaptor 2056 can facilitate wire and/or wireless communications to the LAN 2052, which may also include a wireless access point disposed thereon for communicating with the wireless functionality of the adaptor 2056.

When used in a WAN networking environment, the computer 2002 can include a modem 2058, or is connected to a communications server on the WAN 2054, or has other means for establishing communications over the WAN 2054, such as by way of the Internet. The modem 2058, which can be internal or external and a wire and/or wireless device, connects to the system bus 2008 via the input device interface 2042. In a networked environment, program modules depicted relative to the computer 2002, or portions thereof, can be stored in the remote memory/storage device 2050. It will be appreciated that the network connections shown are exemplary and other means of establishing a communications link between the computers can be used.

The computer 2002 is operable to communicate with wire and wireless devices or entities using the IEEE 802 family of standards, such as wireless devices operatively disposed in wireless communication (e.g., IEEE 802.19 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system, comprising:
a processor component;
a venue user component operative on the processor component to:
create venue profiles for one or more venues, a venue profile comprising a venue name, venue address, and one or more music genres indicative of the type of music played at the venue;
collect, in real-time, music data from the one or more venues, the music data comprising venue data, a song title, an artist name, and a date, the music data indicative of music played at the one or more venues; and
store the venue profiles and music data in a database.

2. The system of claim 1, the venue profile further comprising an upcoming event schedule indicative of music related events scheduled at the one or more venues.

3. The system of claim 1, the venue profile further comprising: telephone contact data for the venue, a website address for the venue, and an indication whether the venue plays live music.

4. The system of claim 1, the music data further comprising request data indicative of music requested at the one or more venues, the request data comprising venue data, a song title, an artist name, and a date.

5. The system of claim 1, comprising:
a mobile user component operative on the processor component to:
receive a venue search query specifying criteria including a music genre and a distance limiter relative to a location, the venue search query received over a network from a requesting device;
search the database for one or more venues located within the distance limiter that include the music genre specified in the music venue query in its venue profile; and
return search results of venues matching the venue search query criteria to the requesting device over the network.

6. The system of claim 5, the search results comprising a map indicating where each matching venue is located, a text listing of each matching venue, and contact information for each matching venue.

7. The system of claim 6, the search results further comprising hyperlinks to the website of the matching venues.

8. The system of claim 6, the search results further comprising hyperlinks to a web page providing the venue profiles of the matching venues.

9. The system of claim 1, comprising:
a business user component operative on the processor component to:
receive a music played query comprising criteria including a date range and at least one of an artist name, a song title, and a venue, the music played query received over a network from a requesting device;
search the database for music data matching the music played query criteria; and
return search results comprised of music data matching the music played query criteria to the requesting device over the network.

10. The system of claim 9, the business user component operative on the processor component to:
receive a music requested query comprising criteria including a date range and at least one of an artist name, a song title, and a venue, the music requested query received over a network from a requesting device;
search the database for music data matching the music requested query criteria; and
return search results comprised of music data matching the music requested query criteria to the requesting device over the network.

11. A computer-implemented method, comprising:
creating venue profiles for one or more venues, a venue profile comprising a venue name, venue address, and one or more music genres indicative of the type of music played at the venue;
collecting, in real-time, music data from the one or more venues, the music data comprising venue data, a song title, an artist name, and a date, the music data indicative of music played at the one or more venues; and
storing the venue profiles and music data in a database.

12. The computer-implemented method of claim 11, the venue profile further comprising an upcoming event schedule indicative of music related events scheduled at the one or more venues.

13. The computer-implemented method of claim 11, the venue profile further comprising: telephone contact data for the venue, a website address for the venue, and an indication whether the venue plays live music.

14. The computer-implemented method of claim 11, the music data further comprising request data indicative of music requested at the one or more venues, the request data comprising venue data, a song title, an artist name, and a date.

15. The computer-implemented method of claim 11, comprising:
receiving a venue search query specifying criteria including a music genre and a distance limiter relative to a location, the venue search query received over a network from a requesting device;
searching the database for one or more venues located within the distance limiter that include the music genre specified in the music venue query in its venue profile; and
returning search results of venues matching the venue search query criteria to the requesting device over the network.

16. The computer-implemented method of claim 15, the search results comprising a map indicating where each matching venue is located, a text listing of each matching venue, and contact information for each matching venue.

17. The computer-implemented method of claim 16, the search results further comprising hyperlinks to the website of the matching venues.

18. The computer-implemented method of claim 16, the search results further comprising hyperlinks to a web page providing the venue profiles of the matching venues.

19. The computer-implemented method of claim 11, comprising:
receiving a music played query comprising criteria including a date range and at least one of an artist name, a song title, number of times played, a music genre and a venue, the music played query received over a network from a requesting device;
searching the database for music data matching the music played query criteria; and
returning search results comprised of music data matching the music played query criteria to the requesting device over the network.

20. The computer-implemented method of claim 11, comprising:
receiving a music requested query comprising criteria including a date range and at least one of an artist name, a song title, number of times played, a music genre and a venue, the music requested query received over a network from a requesting device;
searching the database for music data matching the music requested query criteria; and
returning search results comprised of music data matching the music requested query criteria to the requesting device over the network.

21. At least one computer-readable storage medium comprising instructions that, when executed, cause a system to:
create venue profiles for one or more venues, a venue profile comprising a venue name, venue address, and one or more music genres indicative of the type of music played at the venue;
collect, in real-time, music data from the one or more venues, the music data comprising venue data, a song title, an artist name, and a date, the music data indicative of music played at the one or more venues; and
store the venue profiles and music data in a database.

22. The computer-readable storage medium of claim 26, the venue profile further comprising an upcoming event schedule indicative of music related events scheduled at the one or more venues.

23. The computer-readable storage medium of claim 21, the venue profile further comprising: telephone contact data for the venue, a website address for the venue, and an indication whether the venue plays live music.

24. The computer-readable storage medium of claim 21, the music data further comprising request data indicative of music requested at the one or more venues, the request data comprising venue data, a song title, an artist name, and a date.

25. The computer-readable storage medium of claim 21, comprising instructions that when executed cause the system to:
receive a venue search query specifying criteria including a music genre and a distance limiter relative to a location, the venue search query received over a network from a requesting device;
search the database for one or more venues located within the distance limiter that include the music genre specified in the music venue query in its venue profile; and
return search results of venues matching the venue search query criteria to the requesting device over the network.

26. The computer-readable storage medium of claim 25, the search results comprising a map indicating where each matching venue is located, a text listing of each matching venue, and contact information for each matching venue.

27. The computer-readable storage medium of claim 26, the search results further comprising hyperlinks to the website of the matching venues.

28. The computer-readable storage medium of claim 26, the search results further comprising hyperlinks to a web page providing the venue profiles of the matching venues.

29. The computer-readable storage medium of claim 21, comprising instructions that when executed cause the system to:
receive a music played query comprising criteria including a date range and at least one of an artist name, a song title, and a venue, the music played query received over a network from a requesting device;
search the database for music data matching the music played query criteria; and
return search results comprised of music data matching the music played query criteria to the requesting device over the network.

30. The computer-readable storage medium of claim 21, comprising instructions that when executed cause the system to:
receive a music requested query comprising criteria including a date range and at least one of an artist name, a song title, and a venue, the music requested query received over a network from a requesting device;
search the database for music data matching the music requested query criteria; and
return search results comprised of music data matching the music requested query criteria to the requesting device over the network.
